(19) United States
(12) Patent Application Publication
(10) Pub. No.: US 2010/0032416 A1
(43) Pub. Date: Feb. 11, 2010

(54) Laser Processing Method and Processing Apparatus Based on Conventional Laser-Induced Material Changes

(75) Inventors: Se-Chae Jeong, Daejeon (KR); Ji-Sang Yang, Daejeon (KR); Byoung-Hyeok Jeon, Daejeon (KR); Jae-Hyuk Choi, Daejeon (KR)

Correspondence Address: THE WEBB LAW FIRM, P.C., 700 KOPPERS BUILDING, 436 SEVENTH AVENUE, PITTSBURGH, PA, 15219, US

(73) Assignee: KOREA RESEARCH INSTITUTE OF STANDARDS AND SCIENCE, Daejeon (KR)

(21) Appl. No.: 12/281,385

(22) PCT Filed: Aug. 3, 2006
(86) PCT No.: PCT/KR2006/003051

§ 371 Date: Nov. 24, 2008

(30) Foreign Application Priority Data
Mar. 2, 2006 (KR) 10-2006-0020143

(51) Int. Cl. B23K 26/00

(52) U.S. Cl. 219/121.61; 219/121.76; 219/121.73; 219/121.85

(57) ABSTRACT

The present invention relates to a technique that remarkably increases the processing speed of a conventional ultra-fast laser micro process having a very high processing accuracy. According to the present invention, a laser processing method based on transient changes in the status of laser-induced material couples a pulse of a ultrafast laser to a pulse of at least one auxiliary laser other than the ultrafast laser to reversibly change a material to be processed.

### TECHNICAL FIELD

The present invention relates to a laser processing method based on laser-induced transient changes in the status of material, which non-linearly increases the processing speed of ultrafast laser micro process having a very high processing accuracy.

### BACKGROUND ART

Demands for a micro process become increasingly great along with the development of electronics and device-related technology industry. Particularly, owing to a technical trend toward increased size, reduced film thickness, highly integrated capacity, increased mechanical strength, highly functioned constituent material and multi-layered coating structure of a substrate, demands for micro-process technology for in-process and post-process packaging increase more and more. This process technology requires a process resolution of approximately 100 microns, and hence a diamond sawing method has been generally used. However, the diamond sawing method cannot be used any more because of physical damage such as mechanical and thermal damage in view of current technical development trend. Thus, there is an urgent need for a new technical development to overcome an economic burden such as an increase of cost due to abrasion of an expensive diamond saw blade. To overcome the conventional technical problems, a high-power UV laser has been recently proposed. However, there is a limitation in using the high-power UV laser because of mechanical damage caused by shockwave and photochemical damage of an object material. However, it is required that a processing accuracy of various processes including cutting, drilling, scribing and dicing should be increased up to several tens of micrometers without causing a variation in optical-electrical characteristics of the object material in the process of manufacturing next-generation semiconductor and display devices.

It is known that an ultrafast laser technique can be very effectively applied to the micro-processing because it minimizes thermal-mechanical damage, as compared to conventional various processing techniques using a relatively long laser pulse.

Furthermore, a micro process based on high-energy particles such as an electron beam and plasma may thermally damage materials of components and cannot process a certain material depending on the kind of processing materials. Accordingly, the development of an ultra-short pulse laser processing technique is being actively conducted in an effort to cope with the problems of the micro process based on high-energy particles.

Since the ultrafast laser processing technique does not have an amplification technique indispensable and suitable for increasing a processing speed using sufficient laser power and laser beam characteristic is varied due to high-order nonlinear effect in the air between processes even when there is a laser pulse having sufficient peak power, there is no way to increase the processing speed.

A prerequisite of a new technique to overcome the aforementioned problems is maintenance of characteristics of the ultrafast laser process free of thermal and mechanical damage. The present ultrafast laser based micro process and processing technique are very vulnerable in terms of the processing speed, and thus the development of a new processing technique is urgently needed in application of its future-related technology to the industry. To overcome limitations of the ultrafast laser based micro process, a technique employing adaptive optics that is generally adopted for a conventional relatively long pulse laser process is required because the original ultrafast laser pulse width and beam characteristic are completely changed. When the adaptive optics is employed, particularly, thermal deformation that causes a problem in the conventional relatively long pulse width laser process may deteriorate process quality due to an increase in the pulse width.

### DISCLOSURE

### Technical Problem

Accordingly, the present invention has been made to solve the above-mentioned problems occurring in the conventional art, and a primary object of the present invention is to provide a laser processing method and a processing apparatus based on transient changes in the status of laser-induced material for improving the processing speed of the ultrafast laser based micro process.

Another object of the present invention is to provide a laser processing method and a processing apparatus based on transient changes in the status of laser-induced material that can remarkably reduce surface roughness caused by microscopic structures in a size of several tens to several hundreds of nanometers, which are formed on the surface of a material processed by the ultrafast laser process and enable 1 micron process, and generated when the ultrafast laser process is applied to a micro optic device.

### Technical Solution

To accomplish the objects of the present invention, there is provided a laser processing method based on transient changes in the status of laser-induced material, which couples a pulse of a ultrafast laser with a pulse of at least one auxiliary laser other than the ultrafast laser to reversibly change a material to be processed.

The ultrafast laser oscillates a laser pulse of less than picosecond.

The pulse of the auxiliary laser beam is controlled to be varied with time.

The coupling between the pulse of the ultrafast laser and the pulse of the at least one auxiliary laser is a temporal coupling that controls relative temporal positions between the ultrafast laser pulse and the auxiliary laser pulse.

The coupling between the pulse of the ultrafast laser and the pulse of the at least one auxiliary laser includes the temporal coupling and spatial coupling that spatially accords the focus of the ultrafast laser beam with the focus of the auxiliary laser beam.

The pulse width of the auxiliary laser beam is greater than that of the ultrafast laser beam.

The laser processing method is used in a semiconductor fabrication process selected from cutting, drilling, scribing and dicing.

To accomplish the objects of the present invention, there is also provided a laser processing apparatus based on transient changes in the status of laser-induced material, which comprises a ultrafast laser oscillator, an auxiliary laser oscillator including a coupling electronic device that varies a laser beam pulse with time, and a focusing optical system for spatially coupling the focus of a ultrafast laser beam generated by the ultrafast laser oscillator with the focus of an auxiliary laser beam coupled with time and focusing the ultrafast laser beam and the auxiliary laser beam.

The focusing optical system focuses the auxiliary laser beam inside the focused ultrafast laser beam.

The focusing optical system focuses the auxiliary laser beam outside the focused ultrafast laser beam.

The laser processing apparatus based on transient changes in the status of laser-induced material further comprises a polarization controller disposed between the ultrafast laser oscillator and the focusing optical system, for controlling the angle of a half waveplate using a step motor so as to uniformly maintain optical power of each port, which has passed through a polarization beam splitter.

### ADVANTAGEOUS EFFECTS

The present invention proposes the first ultrafast laser processing technique capable of remarkably increasing the processing speed by temporal-spatially coupling a conventional commercially available laser such as nanosecond laser with a ultrafast laser to locally and transiently change the physical status of a material to be processed, such as either the internal temperature or carrier densities of the material and reversibly induce a transient change of the physical status using relatively small amount of ultrafast laser energy. Specifically, a conventional laser such as a nanosecond laser having appropriate wavelengths is irradiated to the material to be processed to transiently increase the inner temperature of the material or the density of carriers such as free electrons. Here, the energy of the laser is maintained to a degree to which the status of the material is reversibly changed such that the status of the material is not substantially varied. This change of the status of the material allows the process by the ultrafast laser simultaneously irradiated to the same point to remarkably increase the processing speed at the same energy state. Here, the wavelength and pulse width of the auxiliary laser are optimized to three-dimensionally optimize a depth distribution of the physical change of the material, such as either the internal temperature or carrier densities, in consideration of the pulse ablation depth and processing speed of the ultrafast laser. To realize this, the present invention temporally and spatially couples pulses of different lasers.

Furthermore, the present invention can reduce the number of microscopic structures in a size of several tens to several hundreds of micrometers, generated on the surface of the material during the ultrafast laser process, using a coupled nanosecond laser so as to remarkably decrease the surface roughness of the material.

### DESCRIPTION OF DRAWINGS

Further objects and advantages of the invention can be more fully understood from the following detailed description taken in conjunction with the accompanying drawings, in which:

FIG. 1A illustrates a nanosecond/ultrafast laser hybrid process;

FIG. 1B is a photograph of a nanosecond/ultrafast laser hybrid processing apparatus;

FIG. 1C shows pulses at three different time intervals of −100 ns, 0 ns and +100 ns between nanosecond and ultrafst laser pulses;

FIG. 2 illustrates changes in the temperature of an object to be processed and a carrier density and a degree of light-induced reaction in the nanosecond/ultrafast laser hybrid process;

FIG. 3 is a graph showing intervals of pulses of a nanosecond laser and a ultrafast laser in a silicon scribing process;

FIG. 4 is an atomic force microscope picture of a processed silicon surface;

FIG. 5 is a graph showing a profile of a processed cross section; and

FIG. 6 is a graph showing the relationship between variations in intervals of two different lasers and a variation in a processed cross section area.

### DESCRIPTION OF THE NUMERALS OF DRAWINGS

1: Ultrafast laser oscillator
2: Auxiliary laser oscillator
3: Coupling electronic device
4: Focusing optical system

### MODE FOR INVENTION

The present invention will now be described in detail in connection with preferred embodiments with reference to the accompanying drawings.

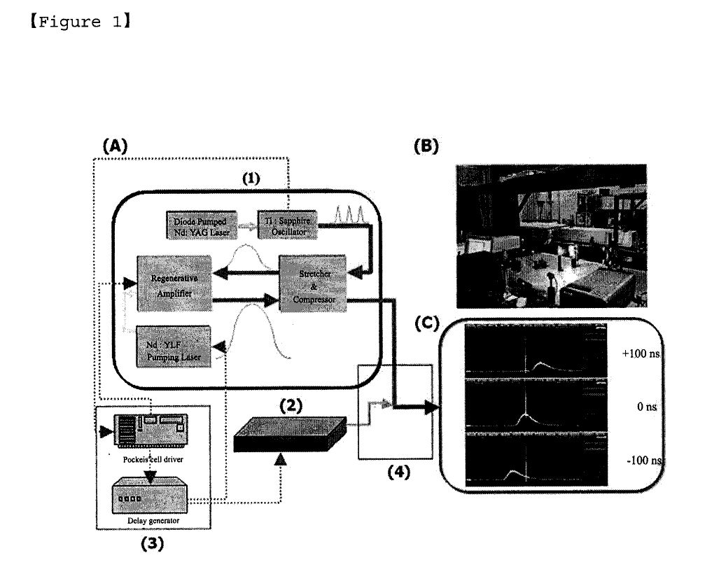

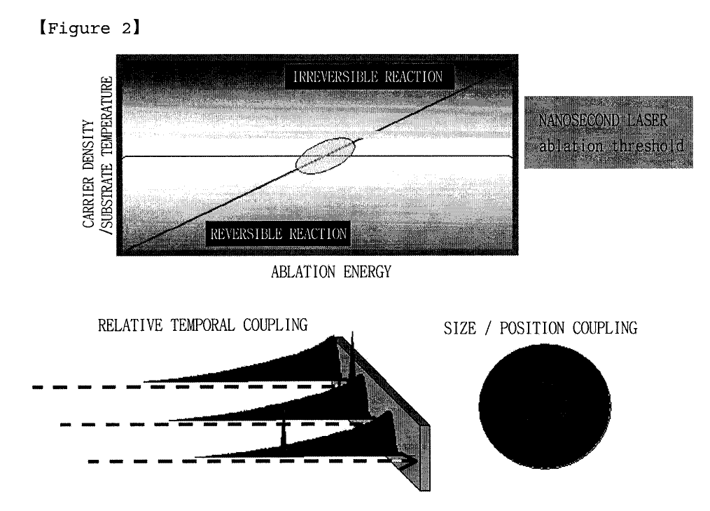

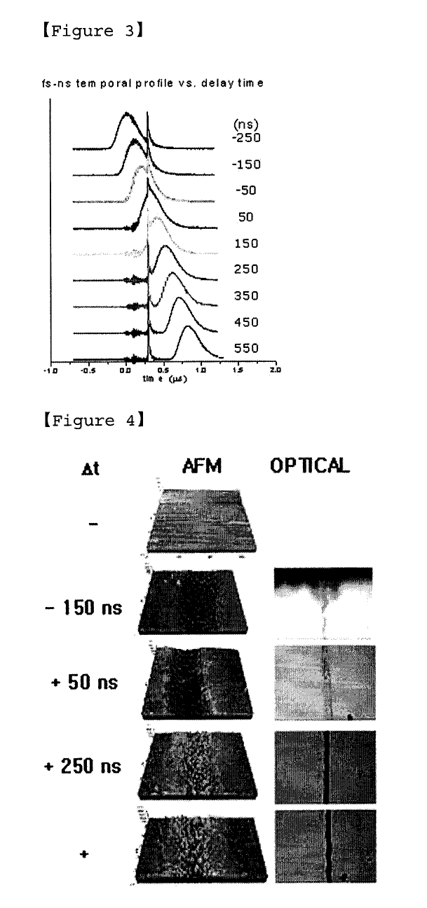

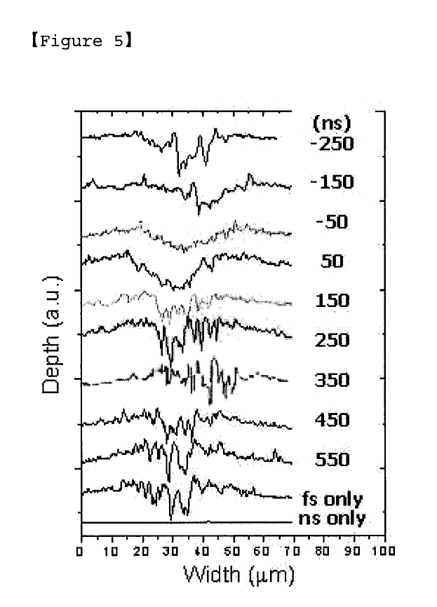

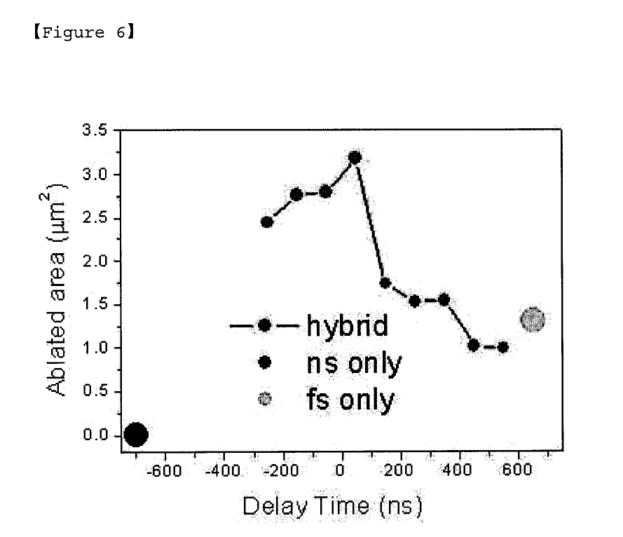

FIG. 1A illustrates a nanosecond/ultrafast laser hybrid process, FIG. 1B is a photograph of a nanosecond/ultrafast laser hybrid processing apparatus, FIG. 1C shows pulses at three different time intervals of −100 ns, 0 ns and +100 ns between nanosecond and ultrafast laser pulses, FIG. 2 illustrates changes in the temperature of an object to be processed and a carrier density and a degree of light-induced reaction in the nanosecond/ultrafast laser hybrid process, and FIG. 3 is a graph showing intervals of pulses of a nanosecond laser and a ultrafast laser in a silicon scribing process. FIG. 4 is an atomic force microscope picture of a processed silicon surface at a different time intervals between nanosecond and ultrafast laser pulses, FIG. 5 is a graph showing a profile of a processed cross section, and FIG. 6 is a graph showing the relationship between variations in intervals of two different lasers and a variation in a processed cross section area. Referring to FIG. 1, a laser processing apparatus based on transient changes in the status of laser-induced material according to the present invention includes a ultrafast laser oscillator 1, an auxiliary laser oscillator 2 having a coupling electronic device 3 for changing a laser beam pulse with time, and a focusing optical system 4 for spatially coupling the focus of a ultrafast laser beam generated by the ultrafast laser oscillator 1 with the focus of an auxiliary laser beam coupled with time and focusing the ultrafast laser beam and the auxiliary laser beam.

The ultrafast laser 1 can use a femtosecond laser or a picosecond laser and the auxiliary laser 2 can use a nanosecond laser. A pulse width of the auxiliary laser beam is longer than that of the ultrafast laser beam.

In the present invention, the femtosecond laser is used as the ultrafast laser 1 and the nanosecond laser oscillator is used as the auxiliary laser oscillator 2.

Temporal coupling of the femtosecond laser and the nanosecond laser means that relative temporal positions between a femtosecond pulse and a nanosecond pulse are controlled to change the physical status of a transient material when the material is laser-processed, and spatial coupling means that the focuses of the femtosecond laser beam and the nanosecond laser beam are accorded with each other. To obtain hybrid effect, the temporal coupling and the spatial coupling are simultaneously required. The femtosecond laser is Ti:Sapphire amplifier system and has a pulse width of 150 fs, a repetition rate of 1 kHz and a wavelength of 800 nm. The nanosecond laser has a pulse width of 250 ns, a repetition rate of 1 kHz and a wavelength of 532 nm.

Stabilization of the nanosecond laser plays a decisive role in the process quality of a hybrid laser processing system. The present invention constructs an extra-cavity stabilization system of the nanosecond laser. The extra-cavity stabilization system includes a polarization beam splitter and a half waveplate and controls the angle of the waveplate using a step motor to approximate a predetermined power value while monitoring a measurement value at a final output stage. As a result, long-term stability of about 2% becomes less than 0.5% after passing through the active stabilizing system to obtain satisfactory stabilization effect. Temporal coupling of the femtosecond pulse and the nanosecond pulse can be controlled by coupling electric signals applied to the femtosecond laser and the nanosecond laser using a delay generator and adjusting a time delay. A photograph of the laser processing apparatus constructed as above is shown in FIG. 1B. FIG. 1C shows the relative temporal positions between the femtosecond pulse and the nanosecond pulse controlled by the aforementioned method. A time interval of approximately −100 ns through several tens of microseconds can be freely given to the pulses of the femtosecond laser and the nanosecond laser by coupling a triggering pulse applied to pockels cells of a green laser required at an amplification stage of the femtosecond layer and a triggering pulse of the nanosecond laser. This is controlled using a computer to result in optimization of the processing speed.

FIG. 2 explains that the temporal coupling of the femtosecond laser and the nanosecond laser causes a local temperature variation of a sample when the sample is processed to reduce ablation threshold energy required for the femtosecond laser process and increase the processing speed. When the energy of the nanosecond laser is increased, the physical status of the processed material, for example, either the material temperature or carrier density in material, is changed. Here, it is possible to control the energy such that the nanosecond laser cannot induce any irreversible change alone. When the coupled femtosecond laser pulse is induced in the same space, irreversible ablation of a large amount of materials can be performed with a small energy. Accordingly, it is expected that the processing speed of the femtosecond laser process can be maximized and the reduction in the process threshold energy remarkably decreases high-order nonlinearity accompanied when the femtosecond laser is focused in the air and deterioration in process quality due to the high-order nonlinearity. Furthermore, the increase in the processing speed can obtain multiplying effect not additive effect when a technique of increasing the repetition rate of the femtosecond laser is improved. Moreover, the processing speed can be further increased by optimizing appropriate spatial change on a focusing plane of the nanosecond laser and the pulse width of the nanosecond laser.

FIG. 2 shows that the nanosecond laser beam is focused inside the femtosecond laser beam focused by the focusing optical system. The focusing optical system can focus the nanosecond laser beam outside the focused femtosecond laser beam. This is very useful for drilling.

FIG. 3 shows pulses applied to a silicon wafer in the hybrid process. In the present invention, a pulse interval of approximately 800 ns is given. The surface of the silicon wafer to which the laser pulses are applied was analyzed with AFM. The measured profile of the processed section is shown in FIG. 4. Referring to FIG. 4, a variation in the processed section is largest when the time interval between the nanosecond laser and the femtosecond laser becomes zero. FIG. 5 shows the relationship between the measured cross section and a variation in the time interval between the nanosecond laser and the femtosecond laser. Referring to FIG. 5, the processing speed is remarkably increased in terms of the cross section. FIG. 6 shows the ablated area as a function of time intervals (delay time) between nanosecond and femtosecond laser pulses. Referring to FIG. 6, the processing speed increased more than ten times in terms of ablation area in its cross section.

A study on evaluation of the influence of a nanosecond laser-induced physical change of a substrate on the femtosecond laser process and development of a technique of optimizing a process condition was applied to a silicon wafer scribing process. Demands for a new next-generation process technology are increased as a process of thinning a silicon wafer in various processes including a packaging process is accelerated. It is difficult to directly apply traditional mechanical sawing method for very thin and hard wafers because a mechanical process such as diamond sawing causes mechanical damage and a processing cost is increased due to abrasion of a diamond saw so that a new process technology is urgently needed. Accordingly, the technology proposed by the present invention is meaningful.

Consequently, the present invention overcomes the limitation of process technology in terms of a processing speed, which is a shortcoming of the conventional ultrafast laser micro process having a high processing accuracy. It is required that the processing speed is improved while maintaining femtosecond laser process characteristics free of thermal and mechanical damage due to technical limitations of femtosecond laser amplification techniques and high-order nonlinear effect in a focusing process. The present invention is the first ultrafast laser process technique capable of remarkably increasing the processing speed using relatively small amount of ultrafast laser energy by temporal-spatially coupling a conventional commercially available laser such as nanosecond laser and ultrafast laser and locally and transiently changing the physical status of a processed material, such as the inner temperature. More specifically, the existing laser such as nanosecond laser having appropriate wavelengths is irradiated to the processed material to transiently increase the inner temperature of the material or the density of carriers such as free electrons. Here, the energy of induced laser is maintained to a degree to which the status of the material is reversibly changed such that the status of the material is not substantially changed. This change in the status remarkably improves a process using a ultrafast laser irradiated to the same point with the same energy. The wavelength and pulse width of the induced laser are optimized to three-dimensionally optimize a depth distribution of the physical change such as the inner temperature of the material in consideration of the ablation depth of a ultrafast laser pulse and the processing speed. To realize this concept, the present invention temporally or spatially couples pulses of different lasers.

### INDUSTRIAL APPLICABILITY

As described above, the present invention can overcome the limitation of the processing speed of a conventional ultrafast laser micro process to remarkably increase the processing speed using a relatively small amount of ultrafast laser energy by temporal-spatially coupling the conventional commercially available laser such as nanosecond laser and femtosecond laser and locally and transiently changing the physical status of a processed material, such as the inner temperature or density of carriers. Accordingly, the present invention contributes to industrialization of the ultrafast laser micro process. Particularly, the present invention enables various processes including cutting, drilling, scribing and dicing necessary to next-generation semiconductor and display processes to which the conventional mechanical process technology cannot be applied. Furthermore, the present invention can improve processing accuracy up to several tens of micrometers without causing a variation in optical-electrical characteristics of the processed material.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A laser processing method based on transient changes in the status of laser-induced material, which couples a pulse of a ultrafast laser with a pulse of at least one auxiliary laser other than the ultrafast laser to reversibly change a material to be processed.

2. The laser processing method based on transient changes in the status of laser-induced material of claim 1, wherein the ultrafast laser oscillates a laser pulse of less than picosecond.

3. The laser processing method based on transient changes in the status of laser-induced material of claim 2, wherein the auxiliary laser pulse is controlled to be varied with time.

4. The laser processing method based on transient changes in the status of laser-induced material of claim 3, wherein the coupling between the pulse of the ultrafast laser and the pulse of the at least one auxiliary laser is temporal coupling that controls relative temporal positions between the ultrafast laser pulse and the auxiliary laser pulse.

5. The laser processing method based on transient changes in the status of laser-induced material of claim 4, wherein the coupling between the pulse of the ultrafast laser and the pulse of the at least one auxiliary laser includes the temporal coupling and spatial coupling that spatially accords the focus of the ultrafast laser beam with the focus of the auxiliary laser beam.

6. The laser processing method based on transient changes in the status of laser-induced material of claim 4, wherein the pulse width of the auxiliary laser beam is greater than that of the ultrafast layer beam.

7. The laser processing method based on transient changes in the status of laser-induced material of any one of claims 1 through 6, wherein the laser processing method based on transient changes in the status of laser-induced material is used in a semiconductor fabrication process selected from cutting, drilling, scribing and dicing.

8. A laser processing apparatus based on transient changes in the status of laser-induced material, comprising:
a ultrafast laser oscillator;
an auxiliary laser oscillator including a coupling electronic device that varies a laser beam pulse with time; and
a focusing optical system for spatially coupling the focus of a ultrafast laser beam generated by the ultrafast laser oscillator with the focus of an auxiliary laser beam coupled with time and focusing the ultrafast laser beam and the auxiliary laser beam.

9. The laser processing apparatus based on transient changes in the status of laser-induced material of claim 8, wherein the focusing optical system focuses the auxiliary laser beam inside the focused ultrafast laser beam.

10. The laser processing apparatus based on transient changes in the status of laser-induced material of claim 8, wherein the focusing optical system focuses the auxiliary laser beam outside the focused ultrafast laser beam.

11. The laser processing apparatus based on transient changes in the status of laser-induced material of claim 9 or 10, further comprising a polarization controller disposed between the ultrafast laser oscillator and the focusing optical system, for controlling the angle of a half waveplate using a step motor so as to uniformly maintain optical power of each port, which has passed through a polarization beam splitter.
